(19) United States
(12) Patent Application Publication
(10) Pub. No.: US 2015/0161639 A1
(43) Pub. Date: Jun. 11, 2015

(54) REWARD DETERMINATION DEVICE, REWARD DETERMINATION METHOD, AND RECORDING MEDIUM

(71) Applicant: Rakuten, Inc., Tokyo (JP)

(72) Inventors: Takehiro Ogita, Tokyo (JP); Rei Kashima, Tokyo (JP); Masashi Inoue, Tokyo (JP)

(73) Assignee: RAKUTEN, INC., Tokyo (JP)

(21) Appl. No.: 14/418,967

(22) PCT Filed: May 16, 2013
(86) PCT No.: PCT/JP2013/063630

§ 371 Date: Feb. 2, 2015

(51) Int. Cl. G06Q 30/02

(52) U.S. Cl. CPC G06Q 30/0214; G06Q 30/0256

(57) ABSTRACT

A reward determination device (100) comprises a presenter (101) and a reward determiner (102). The presenter (101) presents a sales page that shows a first product that is being sold by a first seller in order for a user to be able to purchase the first product, and that includes an advertisement of a second product that is being sold by a second seller on a shopping site for selling products by plural sellers. The reward determiner (102) determines a reward to be given to the first seller when the user purchases the second product from the second seller by way of the advertisement.

### TECHNICAL FIELD

The present invention relates to a reward determination device, a reward determination method, a program and a recording medium, and more particularly to a reward determination device, a reward determination method, a program and a recording medium that determines rewards for a seller in electronic commerce.

### BACKGROUND ART

In recent years, there are many various network shopping sites that are capable of electronic commerce. On a shopping site, plural sellers register information about products being sold, and a user that desires to purchase a product searches for the product by specifying a keyword related to the desired product using a search site or a shopping site. For example, Patent Literature 1 discloses a shopping site on which searches may be performed for a product based on an inputted word or search support word. As a result of the search, the user arrives at a page on which a seller sells a product, and if the product that is being sold is a product that the user wants, the user proceeds to the purchasing procedure. On the other hand, when the product listed on the sales page is not a product that the user desires, or in the case the product listed on the sales page is out of stock, the user usually leaves the shopping site that provides the sales page. In order to deter the user from leaving, the manager of the shopping site desires to present t many sales pages of products that the user desires as well products of other sellers on sales pages besides the sales pages the user arrive at.

### CITATION LIST

### Patent Literature

Patent Literature 1: Unexamined Japanese Patent Application Kokai Publication No. 2011-133926

### SUMMARY OF INVENTION

### Technical Problem

However, there is a problem in that the seller who created the sales page that the user arrived at as a result of the search has a tendency to resist that a user who has arrived at that seller's own sales page is directed to sales pages of products being sold by other sellers, so approval from that seller to do so cannot easily be obtained.

In order to solve the problem described above, the object of the present invention is to provide a reward determination device, a reward determination method, a program and a recording medium that are suitable for determining rewards for sellers so that the products of various sellers can be presented.

### Solution to Problem

The reward determination device according to a first aspect of the present invention comprises:
a presenter that presents a sales page that shows a first product that is being sold by a first seller in order for a user to be able to purchase the first product, and that includes an advertisement of a second product that is being sold by a second seller on a shopping site for selling products by plural sellers; and
a reward determiner that determines a reward to be given to the first seller when the user purchases the second product from the second seller by way of the advertisement.

In the reward determination device according to the aspect above,
when the user arrives at the sales page by specifying a search keyword on a search site, the presenter sets the second product from among products handled on the shopping site based on the search keyword.

In the reward determination device according to the aspect above,
when the user arrives at the sales page by a way other than specifying the search keyword on the search site, the presenter sets the second product based on an action of another user that has already purchased the first product.

In the reward determination device according to the aspect above,
the reward determiner determines the reward based on the number of the first products purchased from the first seller by way of the sales page, and the number of the second products purchased from second seller by way of the advertisement.

In the reward determination device according to the aspect above,
the reward determiner determines the reward based on a sales status of the first product expressed on the sales page.

In the reward determination device according to the aspect above,
when the first product is not purchasable at the time that the sales page is presented, the reward determiner reduces the reward based on a period that the first product is not purchasable, or based on a period until the first product is purchasable.

In the reward determination device according to the aspect above,
the reward determiner reduces the reward based on the number of times that the user browses a sales page on which the first product is not purchasable.

The reward determination method according to a second aspect of the present invention comprises:
a presenting step for presenting a sales page that shows a first product that is being sold by a first seller in order for a user to be able to purchase the first product, and that includes an advertisement of a second products that is being sold by a second seller on a shopping site for selling products by plural sellers; and
a reward determining step for determining a reward to be given to the first seller when the user purchases the second product from the second seller by way of the advertisement.

The program according to a third aspect of the present invention causes a computer to function as:
a presenter that presents a sales page that shows a first product that is being sold by a first seller in order for a user to be able to purchase the first product, and that includes an advertisement of a second product that is being sold by a second seller on a shopping site for selling products by plural sellers; and
a reward determiner that determines a reward to be given to the first seller when the user purchases the second product from the second seller by way of the advertisement.

The non-transitory computer readable medium of a fourth aspect of the present invention storing a program allowing a computer to function as:
a presenter that presents a sales page that shows a first product that is being sold by a first seller in order for a user to be able to purchase the first product, and that includes an advertisement of a second product that is being sold by a second seller on a shopping site for selling products by plural sellers; and
a reward determiner that determines a reward to be given to the first seller when the user purchases the second product from the second seller by way of the advertisements.

The recording medium can be a non-transitory recording medium, and can be distributed or sold separate from the computer. Here, a non-transitory recording medium is a tangible recording medium. A non-transitory recording medium is, for example, compact disk, a flexible disc, a hard disc, a magneto-optical disc, a digital video disc, magnetic tape, a semiconductor memory and the like. Moreover, a transitory recording medium is itself a transmission medium (propagation signal). A transitory recording medium, for example, is an electric signal, an optical signal, an electromagnetic signal and the like. A temporary storage area is an area for temporarily storing data and programs, and for example, is a volatile memory such as a RAM (Random Access Memory).

### Advantageous Effects of Invention

With the present invention, it is possible to provide a reward determination device, a reward determination method, a program and a recording medium that are suitable for setting rewards for sellers so that the products of various sellers can be presented to a user that is searching for a product.

### BRIEF DESCRIPTION OF DRAWINGS

FIG. 1 is a drawing illustrating the relationship among the reward determination device of embodiment of the present invention, a shopping server, seller terminals and user terminals;

FIG. 2 is a drawing illustrating an example of communication that is performed among the reward determination device, the shopping server, the seller terminal and the user terminal;

FIG. 3 is a drawing illustrating the construction of a typical information-processing device that makes possible the provision device of embodiments of the present invention;

FIG. 4 is a drawing illustrating the construction of a reward determination device of a first embodiment of the disclosure;

FIG. 5 is a drawing for explaining a sales page;

FIG. 6 is a drawing for explaining a registered product table;

FIG. 7 is a flowchart for explaining a reward determination process that is performed by the reward determination device of the first embodiment of the disclosure;

FIG. 8 is a drawing for explaining a purchasing user table;

FIG. 9 is a drawing for explaining a browsed page table;

FIG. 10 is a flowchart for explaining a reward determination process that is performed by a reward determination device of a second embodiment of the disclosure;

FIG. 11 is a drawing for explaining a sales performance table;

FIG. 12 is a drawing for explaining a sales page; and

FIG. 13 is a drawing for explaining a sales status table.

### DESCRIPTION OF EMBODIMENTS

In the following, embodiments of the present invention will be explained. The embodiments explained below are for explanation, and do not limit the range of the present invention. Therefore, it is also possible to employ embodiments in which some or all of the elements are replaced with equivalent elements by one skilled in the art, and those embodiments are also included within the range of the present invention.

(1. Overall Construction)

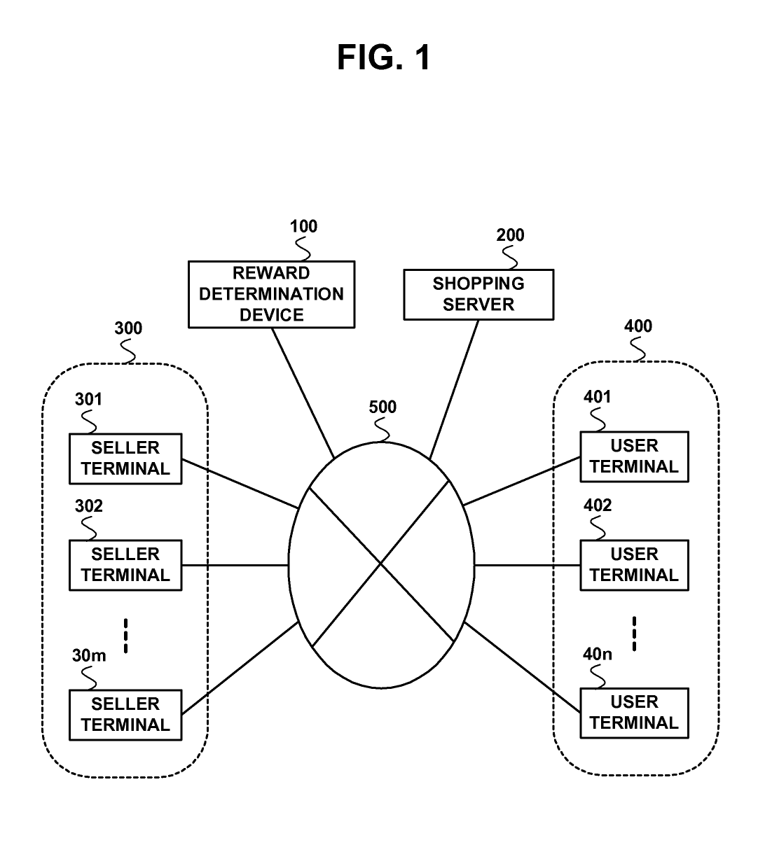

The reward determination device 100 of embodiments of the present invention is connected to the Internet 500 as illustrated in FIG. 1. A shopping server 200, seller terminals 301, 302 to 30m (hereafter, collectively referred to as “seller terminal 300”), and user terminals 401, 402 to 40n (hereafter, collectively referred to as “user terminal 400”) are connected to the Internet 500.

A seller terminal 300 is a terminal that is used by a seller who is selling products on a shopping site.

A user terminal 400 is a terminal that is used by a user who browses and purchases products that are sold by a seller.

The shopping server 200 registers product information that was transmitted from the seller terminal 300 and provides registered product information according to a request from the user terminal 400. Moreover, the shopping server 200 receives an order for a product from the user terminal 400, and transmits information about the order to the reward determination device 100 and the seller terminal 300.

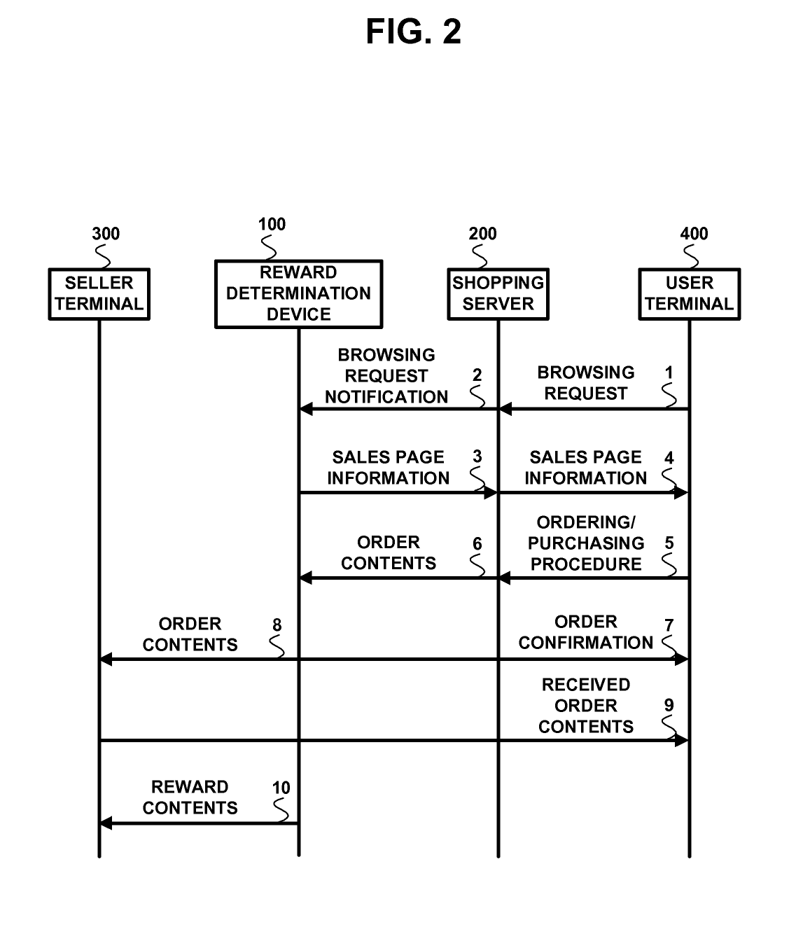

An example of the communication that is performed by the reward determination device 100, shopping server 200, seller terminal 300 and user terminal 400 is explained using FIG. 2.

The user terminal 400 searches for a product by way of a search site or on a shopping site, and then based on the search results, transmits a browsing request to the shopping server 200 in order to browse a desired sales page (1). Here, a sales page is a Web page that includes product information, sales status and the like for products that are being sold by a seller.

The shopping server 200 transmits a notice to the reward determination device 100 indicating that there was a browsing request for the sales page (2).

After receiving the notice from the shopping server 200 indicating that there was a browsing request, the reward determination device 100 transmits information for the sales page that was requested by the user terminal 400 to the shopping server 200 (3).

The shopping server 200 receives the sales page information from the reward determination device 100 and then transmits that sales page information to the user terminal 400 (4).

The user terminal 400 transmits information to the shopping server 200 that is necessary for the ordering and purchasing procedure for purchasing products listed on the sales page (5).

After receiving information from the user terminal 400 that is necessary for the ordering and purchasing procedure, the shopping server 200 transmits the contents of the order to the reward determination device 100 (6).

The shopping server 200 also transmits a notice for confirming the order to the user terminal 400 (7).

Moreover, the shopping server 200 transmits the contents of the order to the seller terminal 300 (8).

The seller terminal 300 receives the contents of the order and then transmits the contents of the received order such as the shipping method and shipping fee for the ordered product to the user terminal 400 (9).

The reward determination device 100, based on the contents of the order, determines a reward to be given to the seller of the purchased product, and transmits the contents of that reward to the seller terminal 300 of that seller (10).

In the example of communication described above, or in the embodiments described below, the reward determination device 100 and the shopping server 200 are connected by way of the Internet as illustrated in FIG. 1; however, the disclosure is not limited to this. For example, the reward determination device 100 and the shopping server 200 can be achieved by the same device. It is also possible for the reward determination device 100 to be directly connected to the shopping server 200.

(2. Basic Construction of an Information Processing Device)

A typical information processing device 600 that makes it possible to achieve the reward determination device 100 of embodiments of the present invention will be explained.

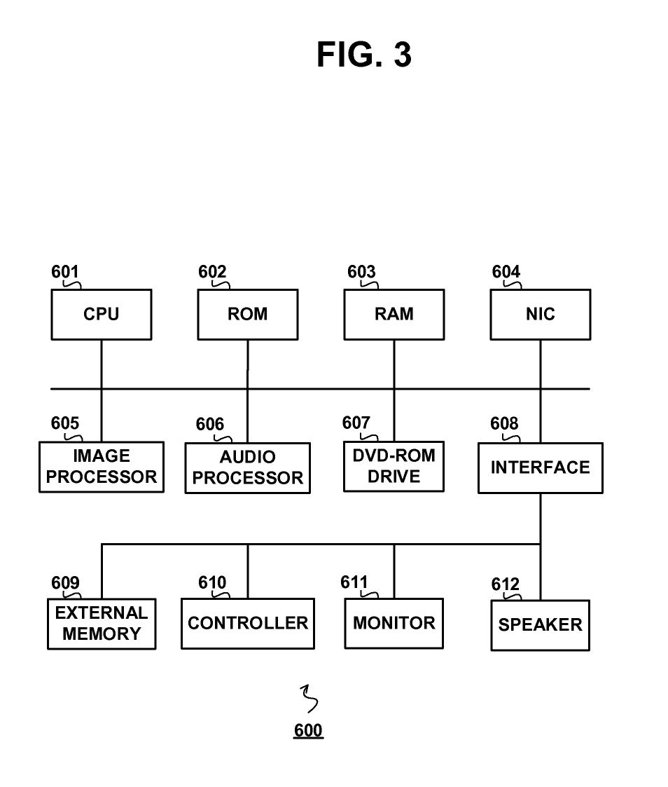

As illustrated in FIG. 3, the information processing device 600 comprises: a CPU (Central Processing Unit) 601, a ROM (Read Only Memory) 602, a RAM (Random Access Memory) 603, a NIC (Network Interface Card) 604, an image processor 605, an audio processor 606, a DVD-ROM (Digital Versatile Disc ROM) drive 607, an interface 608, an external memory 609, a controller 610, a monitor 611, and a speaker 612.

The CPU 601 controls the overall operation of the information processing device 600, and exchanges control signals and data with each of the connected elements.

An IPL (Initial Program Loader) that is activated immediately after the power is turned ON is recorded in the ROM 602; and by executing the IPL, a specified program is read to the RAM 603 and the CPU 601 begins to execute that program. The operating system program and various data that are necessary for controlling the overall operation of the information processing device 600 are also recorded in the ROM 602.

The RAM 603 temporarily stores data and programs, and stores programs and data that are read from a DVD-ROM, as well as other data that are required for communication.

The NIC 604 is for connecting the information processing device 600 to a computer communication network such as the Internet, and comprises an interface (not illustrated) that function as an intermediary between the CPU 601 and a device that complies to the 10BASE-T/100BASE-T standard that is used in building an LAN (Local Area Network), an analog modem, an ISDN (Integrated Services Digital Network) modem or an ADSL (Asymmetric Digital Subscriber Line) modem for connecting to the Internet using a telephone line, a cable modem for connecting to the Internet using a cable television line, or the like.

After the image computation processor (not illustrated in the figure) of the CPU 601 or image processor 605 has processed data that is read from a DVD-ROM or the like, the image processor 605 records the processed data in a frame memory (not illustrated in the figure) of the image processor 605. The image information that is recorded in the frame memory is converted to a video signal at a specified synchronization timing, and then outputted to the monitor 611. As a result, various page displays are possible.

The audio processor 606 converts audio data that was read from a DVD-ROM or the like to an analog audio signal, and outputs that audio signal to a speaker 612 that is connected to the audio processor 606. Under the control of the CPU 601, the audio processor 606 also creates sounds that are to be generated during processing performed by the information processing device 600, and has the speaker 612 output the corresponding sound.

A program for achieving the reward determination device 100 of the embodiments, for example, is stored on a DVD-ROM that is mounted in the DVD-ROM drive 607. Under control of the CPU 601, the DVD-ROM drive 607 reads and processes the mounted DVD-ROM, and reads the necessary program and data, and stores them temporarily in the RAM 603 or the like.

The external memory 609, controller 610, monitor 611 and speaker 612 are connected to the interface 608 so as to be removable.

Data related to the personal information of the user is stored in the external memory 609 so as to be rewritable.

The controller 610 receives operation input that is performed during setting of the information processing device 600. The user of the information processing device 600 can record that data in the external memory 609 by inputting an instruction by way of the controller 610.

The monitor 611 provides the user of the information processing device 600 with data that is outputted from the image processor 605.

The speaker 612 provides the user of the information processing device 600 with audio data that is outputted from the audio processor 606.

In addition, the information processing device 600 can be constructed so that by using a large-capacity external storage device such as a hard disc, the same functions as the ROM 602, RAM 603, external memory 609, DVD-ROM that is mounted in the DVD-ROM drive 607 and the like are achieved.

In the following, the reward determination device 100 that is achieved by the information processing device 600 described above will be explained with reference to FIG. 1 to FIG. 13. After the power is turned ON to the information processing device 600 and a request is received from the shopping server 200, the program that causes the information processing device 600 to function as the reward determination device 100 of the embodiments is executed, and the reward determination device 100 of the embodiments is achieved.

(3. Construction of a Reward Determination Device of a First Embodiment)

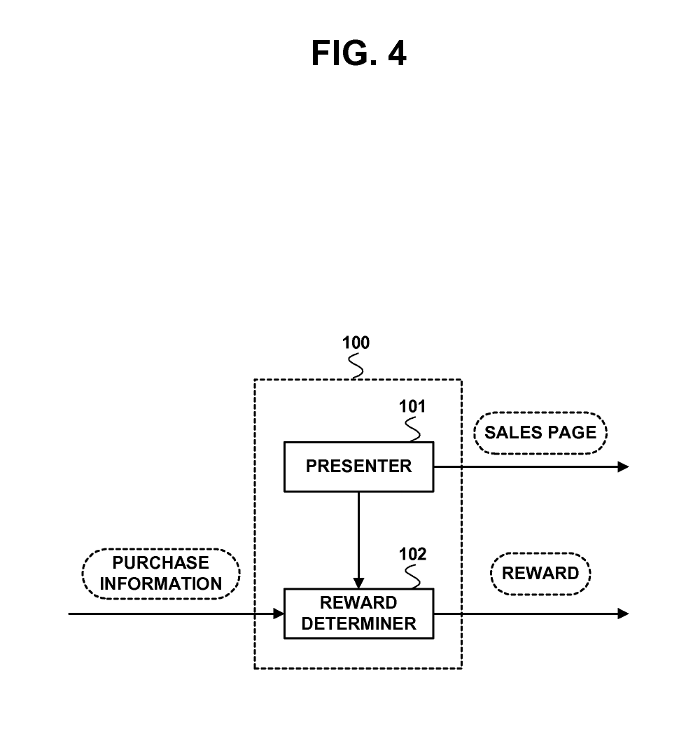

As illustrated in FIG. 4, the reward determination device 100 comprises a presenter 101, and a reward determiner 102.

The presenter 101, on a shopping site for selling products by plural sellers, presents a sales page that shows a first product that is being sold by a first seller and in order for a user to be able to purchase the first product, and that includes an advertisement of a second product that is being sold by a second seller.

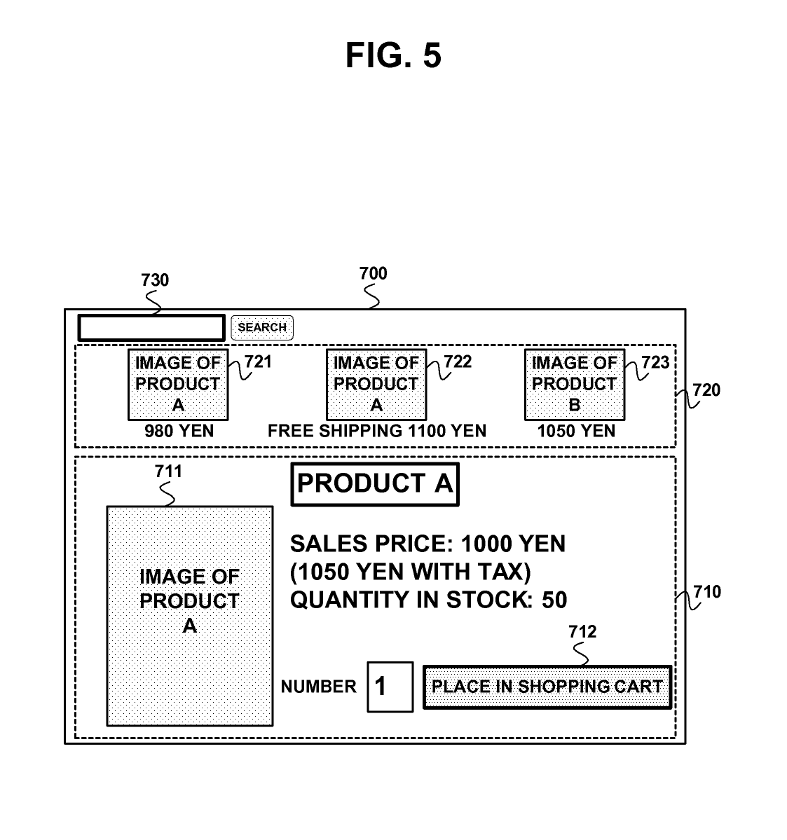

An example of the sales page is illustrated in FIG. 5. In this example, the first product is taken to be product A. There are also plural second products.

A sales page 700 includes first product information 710 and second product advertisements 720.

The information 710 includes information such as an image 711 of product A, the sales price and the number in stock. Moreover, by clicking on the button 712 that is included in the information 710, the user can advance to the purchasing procedure for product A.

The advertisements 720 include images 721 to 723 and sales prices of products handled by second sellers. When the user has interest in any of the products listed in the advertisements 720, the user can click on the images 721 to 723 to move to the sales page for the product in the image.

Here, products that are identical to the first product and that are being sold by second sellers are set as the second products. Similarly, products that are of the same genre as the first product may be set as the second products. Alternatively, it is possible to set the second products based on information about the sales ranking or popular products handled on the shopping site.

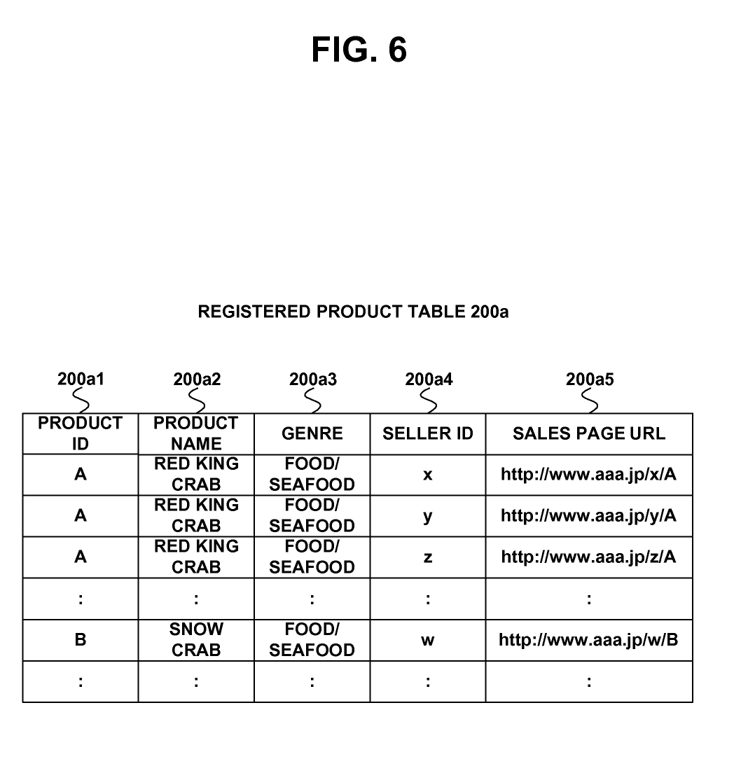

For example, it is presumed that the registered product table 200a illustrated in FIG. 6 is stored in the shopping server 200. Then the registered product table 200a gives information about products handled on the shopping site and about sellers of those products.

The product ID 200a1, product name 200a2, product genre 200a3, seller ID 200a4 of the seller that is selling the product, and the sales page URL 200a5 of the product are associated with each other and registered in the registered product table 200a.

For example, in the first line of the registered product table 200a in FIG. 6, the genre of the product “Red King Crab” having product ID “A” is “Food/Seafood”, the seller of that “Red King Crab” has a seller ID “x”, and the sales page for the “Red King Crab” that is being sold by that seller is “http://www.aaajp/x/A”.

Here, “Product A” is taken to be “Red King Crab”, and “Product B” is taken to be “Snow Crab” in FIG. 5. The presenter 101 references the registered product table 200a, and, for example, sets a product that is identical to the first product “Red King Crab” or “Snow Crab” that is of the same genre as the first product, as a product to be included in the advertisements 720.

For example, the presenter 101 references the registered product table 200a and selects the product “Red King Crab” of the seller having seller ID “y”, the product “Red King Crab” of the seller having seller ID “z”, and the product “Snow Crab” of the seller having seller ID “w”, and presents a sales page 700 (FIG. 5) that includes advertisements 720 in which the images 721 to 723 of each of the products are given.

In this embodiment, the CPU 601 and the image processor 605 work together to function as the presenter 101. This is also the same in the second to fourth embodiments that will be described later.

The reward determiner 102 determines a reward to be given to the first seller when the user purchases the second product from the second seller by way of the advertisement.

For example, it is presumed that after the user arrives at the sales page 700, the user then moves to a sales page of a product listed in the advertisements 720 and purchases the product of that sales page. In that case, a reward is given to the first seller that created the sales page 700.

The reward, for example, is set to be several percent of the price of the second product. The reward determiner 102 determines a reward to be given to the first seller based on the price of the second product each time the second product from the second seller is purchased by way of the advertisement.

In this embodiment, the CPU 601 functions as the reward determiner 102. This is also the same in the second to fourth embodiments to be described later.

With this embodiment, even though the product from the seller that created the sales page was not purchased, by giving that seller a reward when a product from another seller is purchased by way of the advertisement, it is possible to reduce the resistance to placing advertisements for products of other sellers on the sales page at which a user arrives. It is also possible to present the user with products being sold by other sellers, so it is possible to reduce the probability that the user will leave the shopping site.

It can also be made possible for the first seller to be able to freely set whether or not to include advertisements of products by second sellers on the sales page. As a result, it is possible to reduce the probability that a user will leave the shopping site, while at the same time take into consideration the situation of various sellers.

(4. Operation of the Reward Determination Device of the First Embodiment)

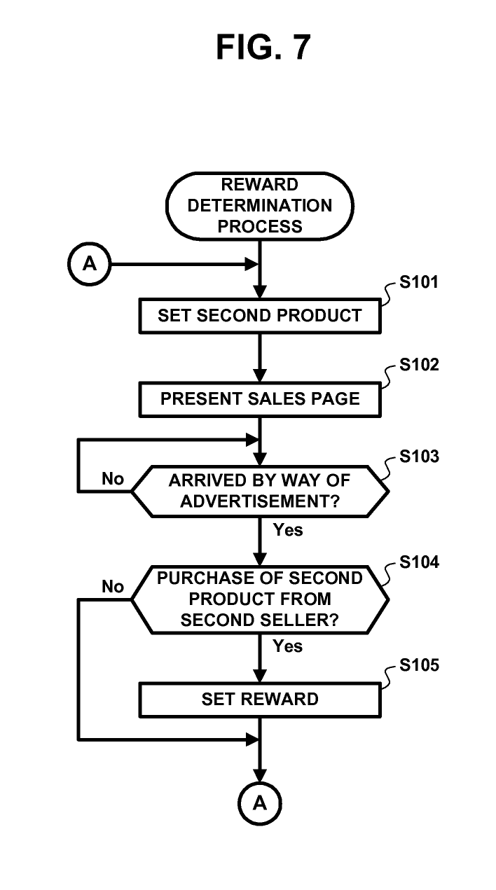

Next, the operation of the reward determination device 100 of this embodiment will be explained. The reward determination device 100, for example, receives a notification from the shopping server 200 indicating that there was a request for browsing a sales page, and then starts the reward determination process illustrated in FIG. 7.

The presenter 101 sets second products that are sold by second sellers (step S101).

For example, when the sales page illustrated in FIG. 5 is taken to be a sales page that is created by a seller having seller ID “x”, the presenter 101 references the registered product table 200a and sets products being sold by second sellers (for example, sellers having the seller IDs “y” and “z”) that are the same as the first product “Red King Crab” that is being sold by the first seller (seller having seller ID “x”) as second products. Alternatively, the presenter 101 sets a product being sold by a second seller (for example, seller having seller ID “w”) that is a product of the same genre as the first product “Red King Crab” that is being sold by the first seller (seller having seller ID “x”) as the second product.

The presenter 101 presents a sales page for a first product being sold by a first seller and that includes advertisements for the second products that are sold by the second sellers (step S102).

For example, as illustrated in FIG. 5, the presenter 101 presents a sales page 700 that includes information for purchasing a product from a seller having seller ID “x”, and advertisements 720 having information about products of sellers having seller IDs “y” “z” and “w”.

The reward determiner 102 determines whether or not a user has arrived by way of the advertisement (step S103). When the reward determiner 102 determines that the user arrived by way of the advertisement (step S103: YES), the reward determiner 102 determines whether or not that user purchased the second product from the second seller (step S104). On the other hand, when the reward determiner 102 determines that the user did not arrive by way of the advertisement (step S103: NO), the reward determiner 102 waits as is.

For example, when the user clicks any of images 721 to 723 that are displayed in the advertisements 720 and moves to the sales page for that product, the reward determiner 102 determines that the user arrived by way of the advertisement. On the other hand, when the user does not arrive by way of an advertisement 720, and the sales page remains at the page of the first seller, the sales page is presented as is and whether or not the user arrives by way of the advertisement is monitored.

In step S104, when the reward determiner 102 determines that the user purchased the second product from the second seller (step S104: YES), the reward determiner 102 determines a reward to be given to the first seller (step S105). On the other hand, when the reward determiner 102 determines that the user did not purchase the second product from the second seller (step S104: NO), the reward determiner 102 returns to step S101.

For example, when the user moves to the sales page of the product illustrated by the image 721 and purchases that product, the reward determiner 102 determines that the user purchased the second product from the second seller, and determines the reward to be given to the first seller of the sales page before moving to the present sales page. On the other hand, when the user moves to the sales page of the product illustrated by the image 721; however, did not proceed to purchase that product, the reward determiner 102 returns to step S101, and the sales page of that second seller continues to be displayed. In this case, step S101 and the subsequent steps are repeated, with the second seller being replaced with the first seller and the second product being replaced with the first product.

When the sales page moves to the sale page of the second seller, the product of the sales page of that second seller can then be taken to be the first product, and the processing of step S101 and step S102 can be performed.

(5. Basic Construction of a Reward Determination Device of a Second Embodiment)

A reward determination device 100 of a second embodiment changes the method for setting the second products according to the history of a user arriving at the sales page.

As illustrated in FIG. 4, the reward determination device 100 comprises a presenter 101 and a reward determiner 102. In this embodiment, the reward determiner 102 has the same function as that of the first embodiment. In the following the presenter 101 that has different functions will be explained.

When the user arrived at the sales page by specifying a search keyword on a search site, the presenter 101 sets the second product from among products handled on the shopping site.

Here, the search site, for example, is a site that provides a function of searching for information that exists on the Internet, and displays sites other than shopping sites.

For example, it is presumed that a user specifies the product name “Red King Crab” of product A as a search keyword on a search site, and arrives at the sales page 700 illustrated in FIG. 5. In this case, the presenter 101 references a referer and acquires the search keyword. The presenter 101 then searches the shopping site using that search keyword, and sets second products (products to be included in the advertisements 720) from the products handled on the shopping site. The second products are products from among products handled on the shopping site that have the same name as the search keyword, products of the same genre as a product indicated by the search keyword or products having the same name as products indicated by the search keyword, and are set based upon a certain specified ranking.

On the other hand, when the user did not arrive at the sales page by specifying the search keyword on the search site, the presenter 101 sets the second products based on the actions of other users that have already purchased the first product.

For example, when the sales page 700 in FIG. 5 is arrived at by specifying the search keyword “Red King Crab” in the search field 730 that is located in the tool bar of the shopping site, or when the sales page 700 in FIG. 5 is arrived at by moving from a sales page of another seller, the second products are set based on the actions of other users that purchased “Red King Crab”.

Here, the actions of other users, for example, include what kind of products other than the first product other users purchased, or what kind of sales pages other users that purchased the first product browsed.

For example, the presenter 101 sets products other than the first product that were purchased by other users that purchased the first product, or products of sales pages that were browsed by those other users, as second products. Alternatively, the presenter 101 sets products that were found based on the purchase results of other users and that are top ranking products in genres that include the first product as the second products.

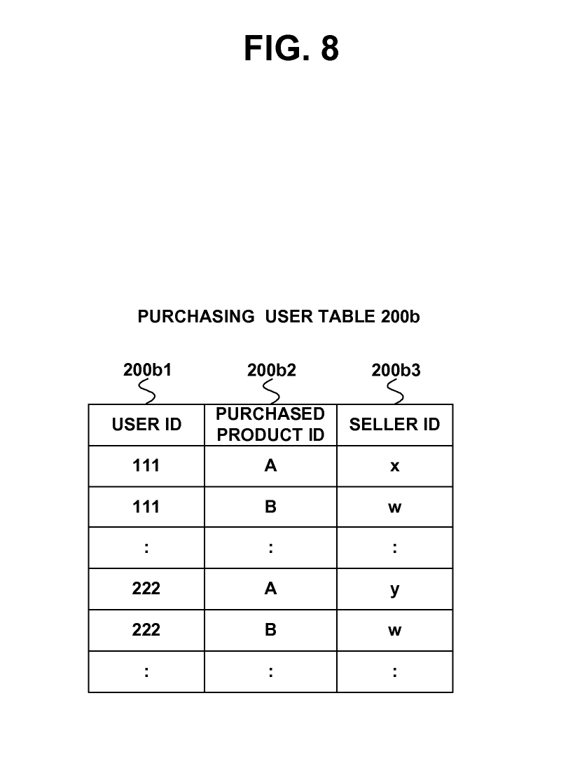

For example, a purchasing user table 200b as illustrated in FIG. 8 is stored on the shopping server 200. This purchasing user table 200b is a table that gives information about users that purchased products from the shopping site, and information about those products.

The user ID 200b1, purchased product ID 200b2 and seller ID 200b3 are associated with each other and registered in the purchasing user table 200b.

For example, the first line in the purchasing user table 200b in FIG. 8 indicates that a user identified by user ID “111” purchased a product identified by product ID “A” from a seller identified by seller ID “x”.

The presenter 101, for example, references the purchasing user table 200b, tallies which products other than the first products were purchased by users that purchased the first product (product ID “A”), and sets the second products according to the tallied results.

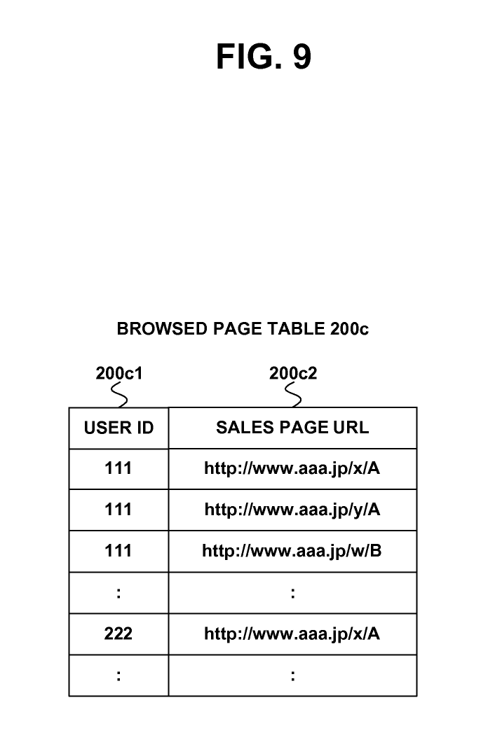

Moreover, it is presumed, for example, that a browsed page table 200c as illustrated in FIG. 9 is stored on the shopping server 200. Information about sales pages that were browsed by users that purchased products from the shopping site is registered in the browsed page table 200c.

The user ID 200c1 and sales page URL 200c2 browsed by the user are associated with each other and registered in the browsed page table 200c.

For example, the first line of the browsed page table 200c in FIG. 9 indicates that a user identified by the user ID “111” browsed the sales page “http://www.aaajp/x/A”.

The presenter 101, for example, references the purchasing user table 200b and browsed page table 200c, tallies which sales pages were browsed by users that purchased the first product, and sets the second products according to the tallied results.

With this embodiment, it is possible to change the products that are included in the advertisements presented to the user according to the site through which the user arrives at the sales page. For example, when a user arrives at a sales page on a shopping site from a search site, it is possible to deter the user from leaving the shopping site by providing the user with various products that are handled on the shopping site and that are related to a search keyword that the user specified. Moreover, when a user arrives at a sales page by searching a shopping site, it can be considered that the user has an intention of shopping on that sales page, so that it is possible to prompt the use to continue shopping on the shopping site by providing the user with products related to the product of that sales page.

(6. Operation of the Reward Determination Device of the Second Embodiment)

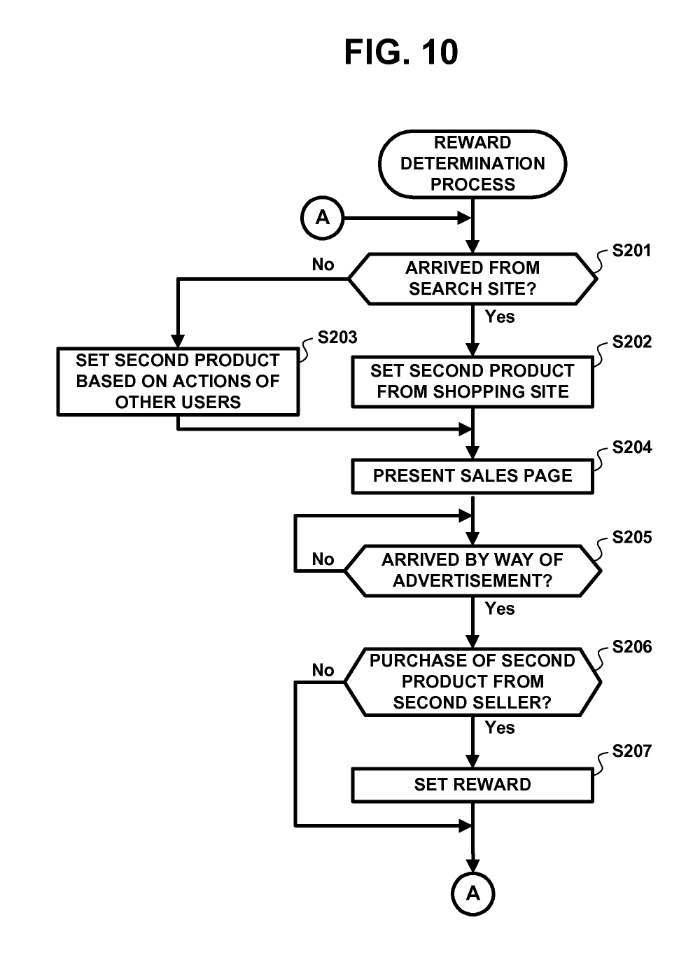

Next, the operation of the reward determination device 100 of this embodiment will be explained. When the reward determination device 100, for example, receives a notification indicating that a request to browse a sales page is received from the shopping server 200, the reward determination device 100 starts the reward determination process that is illustrated in FIG. 10. The processing of step S204 to step S207 of the flowchart in FIG. 10 are the same as step S102 to step S105 of the flowchart in FIG. 7. Therefore, an explanation of these processes will be omitted.

When the reward determination device 100 receives a notification that indicates that there was a request to browse a sales page, as the user arrives at that sales page, the presenter 101 determines whether or not the user arrived at that sales page by specifying a search keyword on a search site (step S201). When the presenter 101 determines that the user arrived at the sales page by specifying the search keyword on the search site (step S201: YES), the presenter 101 sets products from the shopping site as second products based on that search keyword (step S202). On the other hand, when the presenter 101 determines that the user did not arrive at the sales page by specifying the search keyword on the search site (step S201: NO), the presenter 101 sets the second products based on the actions of other users that have already purchased a first product (step S203).

For example, when it is presumed that a user has arrived at the sales page 700 in FIG. 5 by specifying the product name “Red King Crab” of product A as the search keyword on the search site, the presenter 101 determines that the user arrived at the sales page by specifying the search keyword on the search site, and sets the “Red King Crab” products that are handled on the shopping site as the second products. However, when it is presumed that a user has arrived at the sales page 700 in FIG. 5 by specifying the keyword “Red King Crab” in the search field 730 that is located in the tool bar of the shopping site, the presenter 101 determines that the user did not arrive at the sales page by specifying the search keyword on the search site, and sets the second products based on the actions of other users that have purchased “Red King Crab”.

After the second products have been set, the processing starting from step S204 is performed.

(7. Basic Construction of a Reward Determination Device of a Third Embodiment)

A reward determination device 100 of a third embodiment determines a reward to be given to a first seller based on the sales performance of the first seller and second sellers.

As illustrated in FIG. 4, the reward determination device 100 comprises a presenter 101 and a reward determiner 102. In this embodiment, the presenter 101 has the same function as that of the first embodiment. In the following the reward determiner 102 that has different functions will be explained.

The reward determiner 102 determines a reward based on the number of first products that were purchased from a first seller by way of a sales page, and the number of second products that were purchased from a second seller by way of an advertisement.

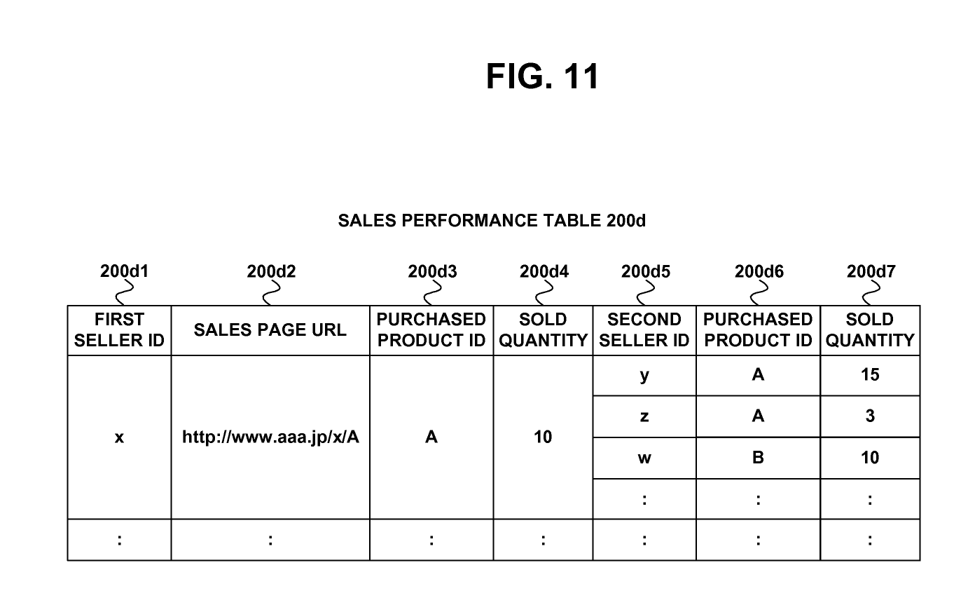

For example, a sales performance table 200d as illustrated in FIG. 11 is stored on the shopping server 200. The sales performance table 200d is a table that gives information about the sales performance of first sellers and second sellers.

The first seller ID 200d1 for identifying the first seller, the URL 200d2 of the sales page created by the first seller, the product ID 200d3 of a product listed on the sales page, the number of sales 200d4 that the first seller has sold of that product, the second seller ID 200d5 for identifying the second seller that sells a product that was purchased by way of the advertisement on the sales page, the product ID 200d6 of the product that was purchased by way of the advertisement, and the number of sales 200d7 that the second seller has sold of that product are associated with each other and registered in the sales performance table 200d.

For example, the first line of the sales performance table 200d in FIG. 11 indicates that the URL of the sales page created by a first seller that is identified by the first seller ID “x” is “http://www.aaa.jp/x/A, the number of the product (product ID “A”) on this sales page that has been purchased is “10”, and the number of the product (product ID “A”) that is being sold by a second seller that is identified by the second seller ID “y” by way of an advertisement on the sales page is “15”.

For example, when the number of product (product ID “A”) that is purchased by way of the sales page “http://www.aaajp/x/A” is “10” and the number of product (product ID “A”) that is purchased by way of the advertisement on that sales page is “15”, the reward determiner 102 determines a total reward to be given to the first seller by multiplying a part of the sales of the product (product ID “A”) of the second seller (second seller ID “y”) that was sold by way of the advertisement by the ratio of the number of sales of the second seller (15) with respect to the total sales of the first seller and second seller (25).

Alternatively, when the number of sales of the first seller is less than the number of sales of the second seller, it is possible to set the reward to be given to the first seller so as to be larger than a specified amount, and when the number of sales of the first seller is greater than the number of sales of the second seller, it is possible to set the reward to be given to the first seller so as to be less than that specified amount.

In this way, even when the number of sales of the product by the second seller that was purchased by way of the advertisement is greater than the number of sales by the first seller, the reward that is given to the first seller becomes larger the greater the number of sales by the second seller is, or, when the number of sales by that second seller is greater than the number of sales by the first seller, the reward that is given to the first seller becomes larger than the specified amount.

Moreover, when, for example, the product on the sales page is different than the product that is purchased by way of the advertisement on the sales page, it can be considered that product in the advertisement is not a cause for reduced number of sales of the product on the sales page, so it is possible to reduce the reward to be paid to the first seller so as to be less than the specified amount.

With this embodiment, when a product on a sales page that is created by a first seller is not purchased, but instead a product that is listed in an advertisement is purchased, it is possible to set the reward to be given to the seller that created the sales page by taking into consideration the contribution that the advertisement had on the sale of the product. As a result, by placing advertisements for products of second sellers on one's own page, a first seller can earn profit according to the contribution of the advertisement, so that it is possible to reduce the resistance of the first seller against directing users to the sales pages of other sellers (second sellers).

(8. Operation of the Reward Determination Device of the Third Embodiment)

The operation of the reward determination device 100 of this embodiment will be explained. The reward determination device 100 of this embodiment performs the following processing in step S105 in FIG. 7 or step S207 in FIG. 10. The other processing is the same as in each of the steps in FIG. 7 or FIG. 10, so an explanation will be omitted.

The reward determiner 102 determines a reward based on the number of a first product that is purchased from a first seller by way of a sales page, and the number of a second product that is purchased from a second seller by way of an advertisement on the sales page (step S105 or step S207).

For example, the reward determiner 102 determines the amount of the reward to be given to the first seller by referencing the sales performance table 200d and finding the ratio of the number of sales (“15”) of the second seller (second seller ID “y”) with respect to the total number of sales (“25”) of the first seller (first seller ID “x”) and the second seller from the number of sales 200d4 of the first seller and the number of sales 200d7 of the second seller, and then multiplying the part of the earnings from the product that the second seller could sell by way of an advertisement by that ratio.

(9. Basic Construction of a Reward Determination Device of a Fourth Embodiment)

A reward determination device 100 of a fourth embodiment determines a reward to be given to a first seller based on the sales status of the product on the sales page of the first seller.

As illustrated in FIG. 4, the reward determination device 100 comprises a presenter 101 and a reward determiner 102. The presenter 101 has the same function as in the first embodiment. In the following, the reward determiner 102 that has a different function will be explained.

The reward determiner 102 determines the reward based on the sales status of the first product that is shown on the sales page.

Here, the sales status is taken to indicate information that is necessary for a user when the user purchases a product, and includes information regarding whether or not it is possible to purchase the product on the sales page (for example, whether or not the product is in stock, or whether or not it is during a sales period), or whether or not the product can be shipped right away (for example, the number of day from the completion of the purchase procedure until the product can be shipped) or the like.

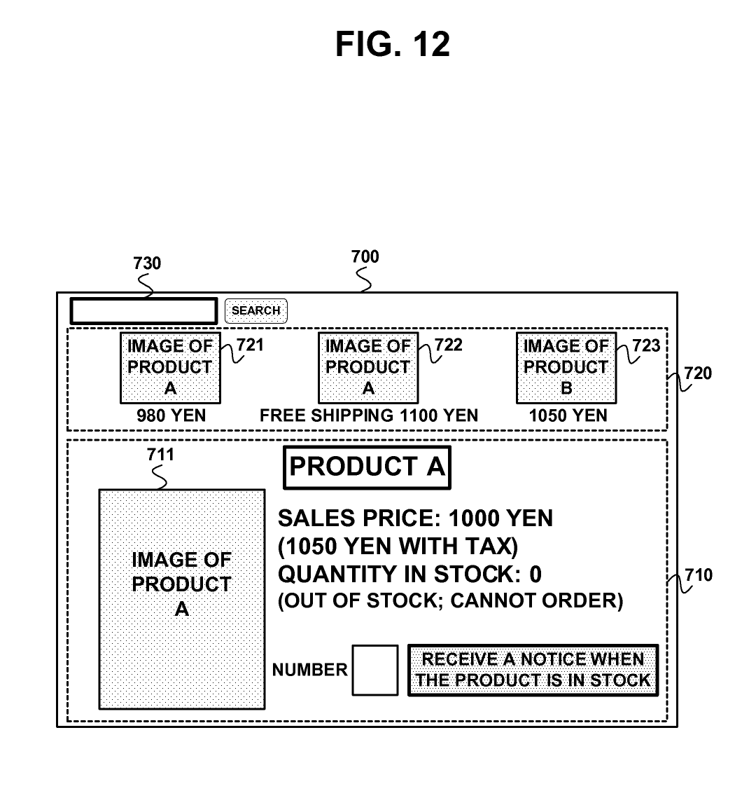

For example, it is presumed that as illustrated in FIG. 12, the product on the sales page that the user arrived at is out of stock and it is not possible to purchase the product right away. In such a case, it is thought that in the case of a user that wants to purchase the product right away, if the same product or similar products are listed in advertisements, the user will naturally search for products of other sellers by way of the advertisements. Therefore, the reason that the user purchases the product from the second seller by way of the advertisement is considered to be due to the first seller, so the reward determiner 102 reduces the reward given to the first seller so as to be less than the specified amount.

Moreover, similarly, when the user arrives at the sales page before the sales period of the product begins and the sales period will begin a few days later, the reason that the user purchases the product from the second seller by way of the advertisement is considered to be due to the first seller, so the reward determiner 102 reduces the reward given to the first seller so as to be less than the specified amount.

Alternatively, when the purchasing procedure for the product on the sales page that the user arrived at is possible, however, the number of days until shipping is possible is greater than a specified number of days (for example, an average number of days) (for example, shipping is possible a few weeks later), it is considered that if the same product or similar products are listed in the advertisements, the user that wants the product as soon as possible will naturally search for the product by another seller by way of that advertisement. In this case as well, the reward determiner 102 reduces the amount of the reward so as to be less than the specified amount. It is possible to further reduce the amount of the reward the greater the number of days until shipping is possible.

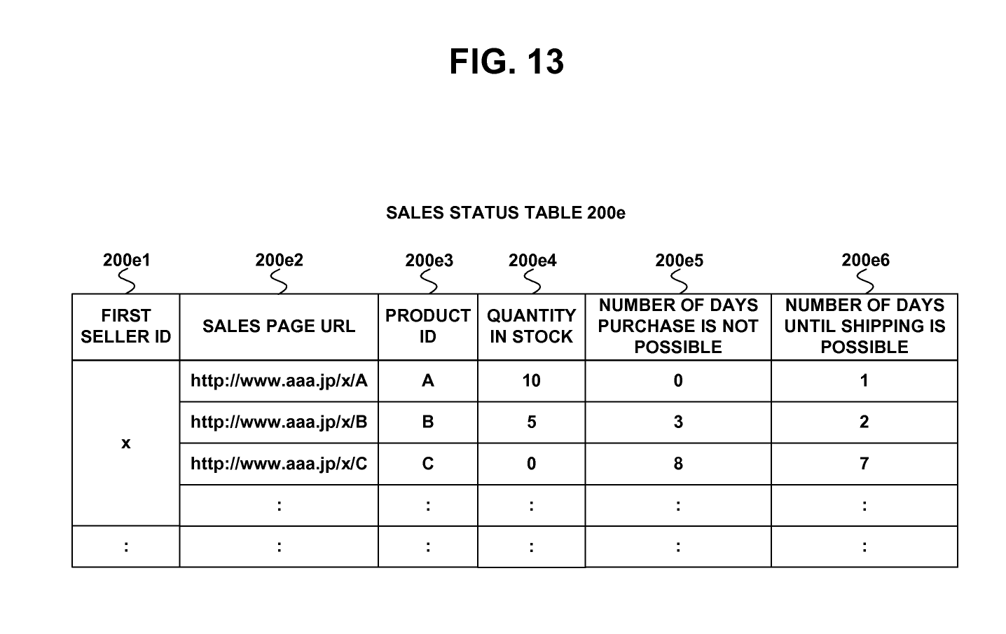

For example, a sales status table 200e such as illustrated in FIG. 13 is stored on the shopping server 200. The sales states table 200e indicates information related to the sales status of the first product that is being sold by the first seller.

The first seller ID 200e1 for identifying the first seller, the URL 200e2 of the sales page that is created by the first seller, the product ID 200e3 of the product that is listed on that sales page, the quantity in stock 200e4 of that product, the number of days that purchasing is not possible 200e5 that indicates the period starting from the present time that the product cannot be purchased, and the number of days until shipping is possible 200e6 that indicates how many days after the product has been purchased the shipping is possible are associated with each other and registered in the sales stats table 200e.

For example, the first line of the sales performance table 200e in FIG. 13 shows that the URL of the sales page that was created by a first seller that is identified by the first seller ID “x” is “http://www.aaa.jp/x/A”, the quantity in stock of the product (product ID “A”) listed on the sales page is “10”, and the number of days that purchasing is not possible is “0”, so that product can be purchased at that time, and when the product is purchased, the table shows that the product can be shipped “1” day after the purchase procedure is completed. In the following example, the number of days until shipping is possible that will be the object of reducing the amount of the reward is taken to be “5” days.

For example, when the second product from the second seller is purchased by way of the advertisement on the sales page “http://www.aaa.jp/x/A”, the reward determiner 102 references the sales performance table 200e in FIG. 13, and finds that the first product (product ID “A”) of the first seller (first seller ID “x”) that created the sales page is not out of stock, that the present time is not a period when purchasing is not possible, and that the number of days until shipping is possible is not the number of days that is the object for reducing the amount of the reward, so that the reward determiner 102 determines the specified amount of the reward as the reward to be given to the first seller.

On the other hand, when a second product from a second seller is purchased by way of the sales page “http://www.aaajp/x/B”, the reward determiner 102 references the sales performance table 200e in FIG. 13 and finds that there is stock of the first product (product ID “A”) of the first seller (first seller ID “x”) that created the sales page, that the number of days until shipping is possible is not the number of days that is the object for reducing the reward, however the present time is a period for which the product cannot be purchased, so the reward determiner 102 determines the amount that is reduced from the specified amount as the reward to be given to the first seller.

In addition, the reward determiner 102 can be such that when it is not possible to purchase the first product at the time that the sales page is presented, the reward determiner 102 reduces the reward based on the period when the first product cannot be purchased, or based on the period until the first product can be purchased.

For example, at the time when the sales page is presented to the user, when it is before the start of the sales period and it is not possible to immediately purchase the product, the longer the period is that purchasing is not possible, the more the reward is reduced so as to be less than the specified amount.

For example, when purchasing the product is not possible until one day after the sales page has been presented to the user, the reward is reduced 1%, when purchasing is not possible until after two days, the reward is reduced 2%, when purchasing is not possible until after three to seven days, the reward is reduced 5%, and when purchasing is not possible until after eight days, the reward is reduced 10%. It is thought that the longer the period when purchasing is not possible, the higher the possibility becomes that the user will look for and purchase a product from another seller, and the first seller posting the sales page for a long period of time during which purchasing the product is not possible is one reason that the product of another seller is purchased, so the reward determiner 102 reduces the reward to be given to the first seller so as to be less than the specified amount.

Moreover, the reward determiner 102 can also be constructed so as to reduce the reward based on the number of times that the user browses the sales page on which the first product cannot be purchased.

Here, the number of times, for example, is the sum of the number of times that the user browsed the sales page of a product that cannot be purchased without purchasing anything, and the number of times that a user browsed the sales page of the product that cannot be purchased and then moved to another sales page and purchased a product.

For example, the reward can be further reduced, the more times that a user browses the sales page on which the first product cannot be purchased. When the sales page of the first seller is browsed many times, it can be considered that the user originally wanted to purchase the product from the first seller, and that the first seller also bears the responsibility that the user was unable to satisfy purchase expectations resulting in the purchase of a product from the second seller. Thus, the reward determiner 102 reduces the reward to be given to the first seller so as to be less than a specified amount.

Moreover, the start of calculating the number of times above is when it becomes impossible to purchase the product, or, when previously it was not possible to purchase the product, and the user moved to another sales page and purchased the second product.

For example, it is presumed that the start of calculating the number of times is when the first product that is being sold by the first seller becomes out of stock. In this case, the reward determiner 102 finds the number of times that the sales page for the first product has been browsed from the time that the first product became out of stock, and when the second product is purchased by way of the advertisement on that sales page, the reward determiner 102 determines the reward to be given to the first seller based on that number of times.

Moreover, for example, it is presumed that the start of calculating the number of times is when the first product that is being sold by the first seller was out of stock the previous time, and the user purchased the second product from the second seller by way of the advertisement. In this case, the reward determiner 102 finds the number of times that the sales page for the first product is browsed again after purchasing the second product from the second seller, and when the second product (can be a different second product than the previously purchased second product) is purchased again by way of the advertisement on the sales page, the reward determiner 102 determines the reward to be given to the first seller based on that number of times.

With this embodiment, by reducing the reward given to the seller that created the sales page, it is possible to prompt that seller to remove the sales page that is not useful for a user that wants to purchase a product from the shopping site.

(10. Operation of the Reward Determination Device of the Fourth Embodiment)

The operation of the reward determination device 100 of this embodiment will be explained. The reward determination device 100 of this embodiment performs the following processing in step S105 in FIG. 7 or step S207 in FIG. 10. The other processing is the same as in each of the steps in FIG. 7 or FIG. 10, so an explanation is omitted.

The reward determiner 102 determines the reward based on the sales status of the first product that is shown on the sales page (step S105 or step S207).

For example, when the product on the sales page 700 (FIG. 12) that the user arrives at is out of stock, the reward determiner 102 reduces the reward that is given to the first seller so as to be less than a specified amount.

### Reference Signs List

100 Reward determination device
101 Presenter
102 Reward determiner
200 Shopping server
300, 301, 302 to 30m Seller terminal
400, 401, 402 to 40n User terminal
500 Internet
600 Information processing device
601 CPU
602 ROM
603 RAM
604 NIC
605 Image processor
606 Audio processor
607 DVD-ROM drive
608 Interface
609 External memory
610 Controller
611 Monitor
612 Speaker
700 Sales page
710 Information
711, 721, 722, 723 Image
712 Button
720 Advertisement

1. A reward determination device comprising:
a presenter that presents a first sales page, a second sales page, and a third sales page that are created by a first seller, a second seller, and a third seller respectively selling a same product, in response to a request from a user, for selling the same product of the first seller, the second seller, and the third seller respectively, wherein the first sales page including a first advertisement advertising the second sales page is presented in response to the request for the first sales page, and the second sales page including the second advertisement advertising the third sales page is presented in response to the request for the second sales page; and
a determiner that determines a reward to be given to the first seller when the user purchases the same product from the second sales page that the user arrived at by way of the first advertisement, and determines a reward to be given to the second seller when the user purchases the same product from the third sales page that the user arrived at by way of the second advertisement.

2. The reward determination device according to claim 1, wherein
when the user arrives at the first sales page by specifying a search keyword on a search site, the presenter sets another sales page whose advertisement is to be further included on the first sales page from among sales pages handled on the shopping site based on the search keyword.

3. The reward determination device according to claim 2, wherein
when the user arrives at the first sales page by a way other than specifying the search keyword on the search site, the presenter sets another sales page whose advertisement is to be further included on the first sales page from among sales pages handled on the shopping site based on an action of another user that has already purchased the same product.

4. The reward determination device according to claim 1, wherein
the determiner determines the reward based on the number of the same products purchased from the first seller by way of the first sales page, and the number of the same products purchased from the second seller by way of the advertisement.

5. The reward determination device according to claim 1, wherein
the determiner determines the reward based on a sales status of the same product expressed on the first sales page.

6. The reward determination device according to claim 5, wherein
when the same product is not purchasable at the time that the first sales page is presented, the determiner reduces the reward based on a period that the same product is not purchasable, or based on a period until the same product is purchasable.

7. The reward determination device according to claim 5, wherein
the determiner reduces the reward based on the number of times that the user browses the first sales page on which the same product is not purchasable.

8. A reward determination method comprising:
a presenting step in which a reward determination device presents a first sales page, a second sales page, and a third sales page that are created by a first seller, a second seller, and a third seller respectively selling a same product, in response to a request from a user, for selling the same product of the first seller, the second seller, and the third seller respectively, and presents the first sales page including a first advertisement advertising the second sales page, in response to the request for the first sales page, and presents the second sales page including a second advertisement advertising the third sales page, in response to the request for the second sales page; and
a reward determining step in which the reward determination device determines a reward to be given to the first seller when the user purchases the same product from the second sales page that the user arrived at by way of the first advertisement, and determines a reward to be given to the second seller when the user purchases the same product from the third sales page that the user arrived at by way of the second advertisement.

9. (canceled)

10. A non-transitory computer-readable medium storing a program allowing a computer to function as:
a presenter that presents a first sales page, a second sales page, and a third sales page that are created by a first seller, a second seller, and a third seller respectively selling a same product, in response to a request from a user, for selling the same product of the first seller, the second seller, and the third seller respectively, wherein the first sales page including a first advertisement advertising the second sales page is presented in response to the request for the first sales page, and the second sales page including a second advertisement advertising the third sales page is presented in response to the request for the second sales page; and
a determiner that determines a reward to be given to the first seller when the user purchases the same product from the second sales page that the user arrived at by way of the first advertisement, and determines a reward to be given to the second seller when the user purchases the same product from the third sales page that the user arrived at by way of the second advertisement.

11. A reward determination device comprising:
a presenter that presents sales pages that are created by a plurality of sellers respectively selling a same product, in response to a request from a user, for selling the same product of the plurality of sellers respectively, wherein the sales page including an advertisement of a sales page created by a seller other than the seller that created the presented sales page out of a plurality of sellers selling the same product is presented in response to the request from the user; and
a determiner that determines a reward to be given to the seller that created the sales page that includes the advertisement, when the user purchases the same product from the sales page that the user arrived at by way of the advertisement.
